(19) United States
(12) Patent Application Publication
(10) Pub. No.: US 2007/0035949 A1
(43) Pub. Date: Feb. 15, 2007

(54) Methods and apparatus for operating very high pressure short arc discharge lamps

(75) Inventors: Nanu Brates, Winchester, MA (US); Jakob Maya, Brookline, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Matsushita Electric Works, Ltd., Osaka (JP)

(21) Appl. No.: 11/200,802

(22) Filed: Aug. 10, 2005

(51) Int. Cl. F21V 23/04

(52) U.S. Cl. 362/276

(57) ABSTRACT

A high pressure discharge lamp system and a method for operating a high pressure discharge lamp are provided. The method includes rotating the discharge lamp around its longitudinal axis. The discharge lamp or a lamp assembly including the discharge lamp and a reflector may be rotated through specified angles at specified times or intervals, or upon the occurrence of specified events. The discharge lamp may be rotated when the lamp is deenergized or when the lamp is energized. The discharge lamp may be rotated by a predetermined angle before operation, after operation, or after a predetermined burn time. The lamp system includes a rotation mechanism coupled to the lamp assembly and configured to rotate the discharge lamp about its longitudinal axis.

### FIELD OF THE INVENTION

This invention relates to arc discharge lamps and, more particularly, to methods and apparatus for operating high pressure discharge lamps to extend operating life.

### BACKGROUND OF THE INVENTION

High pressure discharge lamps include an arc tube containing an inert gas, mercury vapor and two electrodes positioned at opposite ends of the arc tube. An arc discharge is established in the arc tube by supplying an electrical current to the electrodes. A very high pressure discharge lamp is typically utilized for projection applications, where the optical system requires point-like sources. To achieve such optical performance, the arc length must be on the order of 1.0-1.5 millimeters. The lamps typically include an arc tube constructed of heat resistant and optically transparent material such as quartz, tungsten electrodes, mercury vapor and an inert starting gas. The electrodes include a tungsten rod with a tungsten coil attached to one end.

Typically, the quartz arc tube of a very high pressure discharge lamp reaches high temperatures close to, or even exceeding, 1,000° C. This elevated wall temperature is necessary to maintain the mercury vapor pressure at the design value. Accordingly, operation of very high pressure discharge lamps is optimized to achieve the most beneficial quartz wall temperature.

A problem in providing the optimal temperature of the quartz arc tube arises when the lamp voltage increases over the life of the lamp. To maintain constant power conditions, the power supply reduces the lamp current proportionally. As a result, the arc discharge bows upwardly due to thermal buoyancy and locally increases the inner wall quartz temperature. Furthermore, a very high pressure discharge lamp is usually mounted in a reflector, which changes the thermal environment of the arc tube. One side of the lamp, typically the top, may be hotter than the bottom, due to gas convection inside the arc tube. Consequently, the quartz material may devitrify, shortening the useful life of the lamp.

In typical applications, very high pressure discharge lamps are operated with forced air cooling. The cooling is usually directed to both sides of the lamp or to the upper side of the lamp. Depending on the configuration of the cooling air flow, different lamp performance is achieved.

During the lifetime of the discharge lamp, the inner portion of the arc tube may devitrify. Quartz devitrifies when subjected to high temperature by changing locally from an amorphous phase, i.e., pure quartz, to a crystalline phase called cristobalite. This process leads to early lamp failure.

Accordingly, there is a need for improved methods and apparatus for operating high pressure discharge lamps.

### SUMMARY OF THE INVENTION

According to a first aspect of the invention, a method is provided for operating a high pressure discharge lamp. The method comprises rotating the discharge lamp around its longitudinal axis.

The discharge lamp or a lamp assembly including the discharge lamp and a reflector may be rotated through specified angles at specified times or intervals, or upon the occurrence of specified events. The discharge lamp may be rotated when the lamp is deenergized or when the lamp is energized. The discharge lamp may be rotated by a predetermined angle before operation, after operation or after a predetermined burn time. The rotation may be bidirectional in the case of conventional connections between the discharge lamp and a power supply. Rotation may be unidirectional when slip connections are utilized between the discharge lamp and the power supply.

According to a second aspect of the invention, a high pressure discharge lamp system is provided. The lamp system comprises a lamp assembly including a reflector and a high pressure discharge lamp mounted in the reflector, the discharge lamp having a longitudinal axis, and a rotation mechanism coupled to the lamp assembly and configured to rotate at least the discharge lamp about its longitudinal axis.

### BRIEF DESCRIPTION OF THE DRAWINGS

For a better understanding of the present invention, reference is made to the accompanying drawings, which are incorporated herein by reference and in which:

FIG. 1 is a schematic block diagram of a lamp system in accordance with a first embodiment of the invention;

FIG. 2 is a schematic block diagram of a lamp system in accordance with a second embodiment of the invention; and

FIG. 3 illustrates a high pressure discharge lamp with different hottest spot locations due to rotation of the discharge lamp.

### DETAILED DESCRIPTION

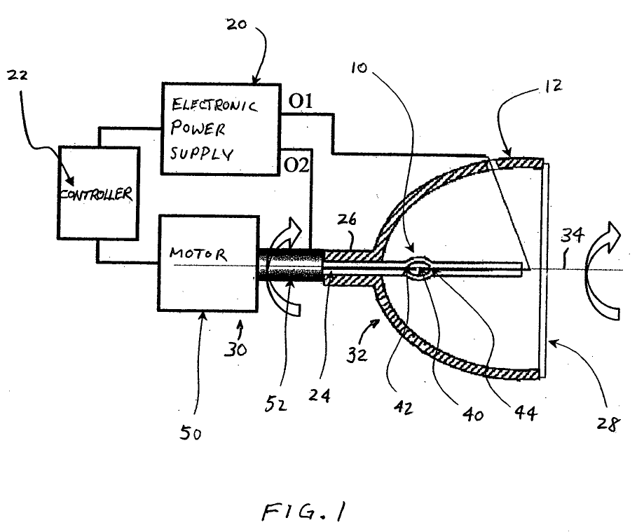

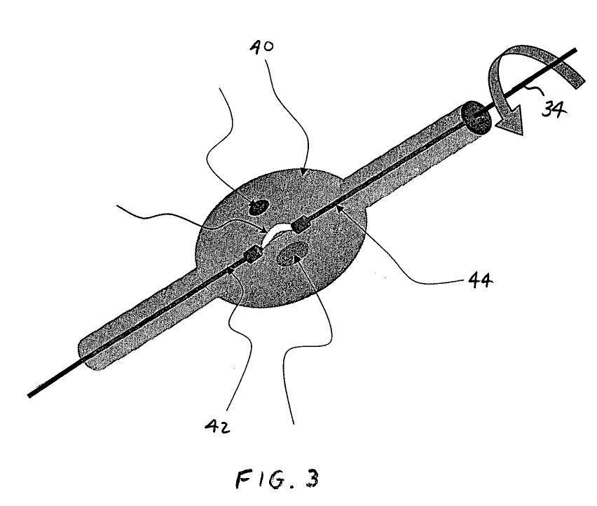

A schematic block diagram of a lamp system in accordance with a first embodiment of the invention is shown in FIG. 1. An embodiment of a high pressure discharge lamp is shown in FIG. 3. The lamp system includes a high pressure discharge lamp 10, a reflector 12, and a rotation mechanism 30. The lamp system may further include an electronic power supply 20 and a controller 22. Discharge lamp 10 is mounted in reflector 12. One end 24 of discharge lamp 10 is secured in a neck 26 of reflector 12. The reflector 12 is enclosed by a transparent glass member 28.

Discharge lamp 10 and reflector 12 may constitute a lamp assembly 32. Discharge lamp 10 has a longitudinal axis 34. The lamp assembly may be operated with longitudinal axis 34 in a horizontal or nearly horizontal position.

High pressure discharge lamps typically include an arc tube 40 constructed of a heat resistant and optically transparent material, such as quartz. Tungsten electrodes 42 and 44 are mounted at opposite ends of arc tube 40, and the interior volume of arc tube 40 contains mercury vapor and an inert starting gas. Each of electrodes 42 and 44 may include a tungsten rod having a tungsten coil attached to one end. Electrodes 42 and 44 are separated by an electrode distance, called the arc length. By way of example, very high pressure short arc mercury discharge lamps are used for projection applications. To achieve a desired optical performance, the arc length may be on the order of 1.0-1.5 millimeters for projection applications. The electrodes are affixed to opposite ends of arc tube 40 by press pinching or by vacuum sealing. The electrodes are connected by appropriate electrical wiring to respective output terminals O1 and O2 of electronic power supply 20.

Electronic power supply 20 may include a power circuit and an ignition circuit. When electronic power supply 20 is connected to an AC voltage supply, the power circuit generates an alternating current having successive periods of alternate polarity and a predetermined shape. By way of example, the alternating current may be a square wave. However, the alternating current is not limited as to wave shape. The ignition circuit ensures lamp starting.

Rotation mechanism 30 may include a motor 50 and a mechanical coupler 52. Mechanical coupler 52 provides a mechanical coupling between a shaft of motor 50 and the neck 26 of reflector 12. Rotation mechanism 30 is configured for rotation of discharge lamp 10 around longitudinal axis 46. Motor 50 is selected for rotation of discharge lamp 10 by predetermined angles at specific times or intervals, or upon the occurrence of specified events. By way of example only, the discharge lamp 10 may be rotated by 30° each time it is energized or deenergized. The rotation mechanism 30 may include a stepper motor for controlled rotation of discharge lamp 10. In other embodiments, rotation mechanism 30 may include any electromechanical device that can rotate discharge lamp 10 in a controlled manner.

Rotation mechanism 30 may rotate discharge lamp 10 alone or lamp assembly 32. In practical implementations, it may be more convenient to rotate discharge lamp 10 and reflector 12 together.

Controller 22 controls electronic power supply 20 and rotation mechanism 30 to coordinate operation of the lamp system as described below. Thus, for example, controller 22 may cause rotation mechanism 30 to rotate discharge lamp 10 prior to ignition of discharge lamp 10 or may cause rotation mechanism 30 to rotate discharge lamp 10 after power to discharge lamp 10 is turned off.

According to embodiments of the invention, a high pressure discharge lamp is operated by rotating the discharge lamp alone or the lamp assembly, including discharge lamp 10 and reflector 12, around its longitudinal axis through specified angles at specified times or intervals, or upon the occurrence of specified events. In other embodiments, the discharge lamp is rotated continuously. Thus, the discharge lamp can be rotated continuously or in increments.

It has been discovered that with controlled rotation of the discharge lamp, it is possible to preserve the inner surface of the quartz arc tube substantially free from devitrification. This results from the fact that a certain incubation time is required for the formation of cristobalites on the inner surface of the quartz arc tube at it hottest spot, typically the top. Cristobalite is a polymorph of quartz, meaning that it has the same chemistry, SiO₂, but has a different structure. Accordingly, the lamp assembly is rotated around its longitudinal axis by a specified angle, such that the hottest spot is located on a new quartz surface.

As shown in FIG. 3, an arc discharge 60 between electrodes 42 and 44 of discharge lamp 10 bows upwardly and produces a hottest spot 62 on the inner wall of quartz arc tube 40. When discharge lamp 10 is rotated around longitudinal axis 34, arc discharge 60 produces a hottest spot 64 at a new location on the inner wall of quartz arc tube 40.

The rotation may be performed at any time but is preferably performed before the lamp is energized, at the end of operation after the lamp is deenergized, or at preset intervals of lamp operation. Thus, for example, the discharge lamp may be rotated by 30° each time the lamp is energized. In other embodiments, the discharge lamp 10 may be rotated after a predetermined burn time, such as 100 hours. In further embodiments, rotation of the lamp assembly may be performed in various increments, such as 15°, 30°, 45°, 90°, etc. When a full revolution has been completed, the direction of rotation may be reversed and a present angular offset may be utilized, such that the new arc tube hottest spot location is shifted azimuthally by a known angle with respect to the hottest spot locations on the first revolution. Thus, for the example of angular increments of 30°, an angular offset of 15° may be utilized for the first increment of the second rotation. This causes the hottest spot locations on the second rotation to be equally spaced between the hottest spots on the first rotation. In further embodiments, discharge lamp 10 can be rotated during lamp operation after a preset burning time, such as 100 hours. In additional embodiments, the size of the angular increments of rotation is increased as the discharge lamp ages.

As indicated above, controller 22 may be utilized to schedule the rotation of discharge lamp 10 with turn-on or turn-off of the lamp system. Each time before the discharge lamp is started, rotation mechanism 30 rotates discharge lamp 10 by a predetermined angle, for example, 30° clockwise. The next time the discharge lamp is energized, rotation mechanism 30 again rotates the lamp assembly by the predetermined angle, such as 30° clockwise. The process repeats until the lamp assembly completes a full revolution. At this point, the rotation changes direction from clockwise to counterclockwise. To prevent repositioning the lamp at the same azimuthul orientation, an angular offset is introduced, such that in the new orientation the hottest spot of the discharge lamp is not at the same location as in the previous revolution. Thus, the first increment of the counterclockwise rotation may be 15° and subsequent increments of the counterclockwise rotation may be 30° until the lamp assembly has completed a full revolution.

In the embodiment of FIG. 1, rotation of the lamp assembly is bidirectional to permit fixed electrical connections between discharge lamp 10 and electronic power supply 20. In this embodiment, the direction of rotation is reversed after a known rotation, such as 360°. It will be understood that the direction of the rotation may be reversed after rotation through an angle greater than or less than 360°, within the limits of the electrical connection to discharge lamp 10.

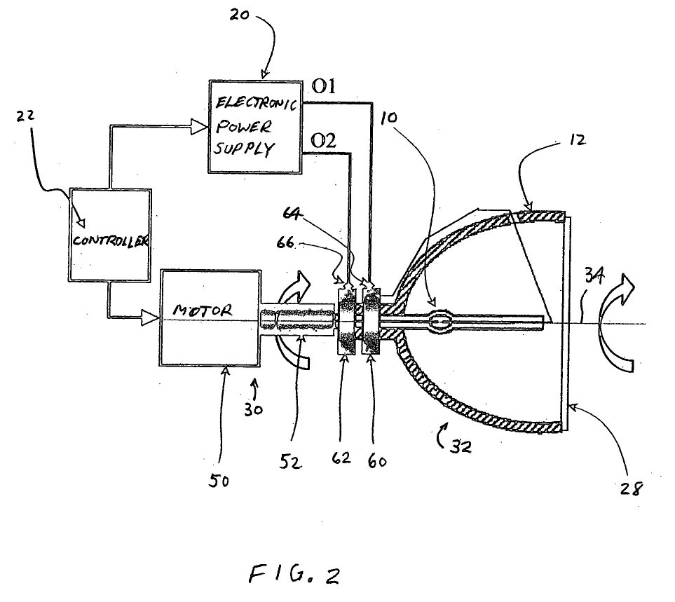

A second embodiment is illustrated in FIG. 2. Like elements in FIGS. 1 and 2 have the same reference numerals. In the embodiment of FIG. 2, output terminals O1 and O2 of electronic power supply 20 are connected to the electrodes of discharge lamp 10 through slip rings 60 and 62 and sliding contacts 64 and 66, respectively. This arrangement permits unidirectional rotation of discharge lamp 10 while maintaining the electrical connections between electronic power supply 20 and discharge lamp 10.

In each case, the discharge lamp is rotated such that new areas of the quartz arc tube are the hottest spot of the arc tube during operation. The purpose of the rotation is to distribute the area that serves as the hottest spot of the arc tube over the inner wall of the arc tube.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for operating a high pressure discharge lamp having a longitudinal axis, comprising:
rotating the discharge lamp around its longitudinal axis.

2. A method as defined in claim 1, wherein rotating comprises rotating a lamp assembly including the discharge lamp and a reflector.

3. A method as defined in claim 1, wherein rotating comprises rotating the discharge lamp when the discharge lamp is deenergized.

4. A method as defined in claim 3, wherein rotating comprises rotating the discharge lamp before the discharge lamp is energized.

5. A method as defined in claim 3, wherein rotating comprises rotating the discharge lamp after the discharge lamp is deenergized.

6. A method as defined in claim 1, wherein rotating comprises changing a direction of rotation after a predetermined rotation of the discharge lamp.

7. A method as defined in claim 1, wherein rotating comprises rotating the discharge lamp in one direction.

8. A method as defined in claim 1, wherein rotating comprises rotating the discharge lamp when the discharge lamp is energized.

9. A method as defined in claim 8, wherein rotating comprises rotating the discharge lamp at preset intervals.

10. A method as defined in claim 1, wherein rotating comprises rotating the discharge lamp assembly in predetermined increments.

11. A method as defined in claim 10, wherein rotating comprises varying a size of the increments.

12. A method as defined in claim 10, wherein rotating comprises rotating by an angular offset which is different from the predetermined increments.

13. A method is defined in claim 1, wherein rotating comprises rotating the discharge lamp after a predetermined burn time.

14. A high pressure discharge lamp system comprising:
a lamp assembly including a reflector and a high pressure discharge lamp mounted in the reflector, the discharge lamp having a longitudinal axis; and
a rotation mechanism coupled to the lamp assembly and configured to rotate at least the discharge lamp around its longitudinal axis.

15. A lamp system as defined in claim 14, wherein the high pressure discharge lamp comprises a very high pressure short arc mercury discharge lamp.

16. A lamp system as defined in claim 14, further comprising a controller to operate the rotation mechanism when the discharge lamp is deenergized.

17. A lamp system as defined in claim 14, further comprising a controller to change a direction of rotation after a predetermined rotation of the discharge lamp.

18. A lamp system as defined in claim 14, further comprising a controller to rotate the discharge lamp in predetermined increments.

19. A lamp system as defined in claim 18, wherein the controller varies a size of the increments.

20. A lamp system as defined in claim 14, wherein the rotation mechanism comprises a stepper motor and a coupler between the stepper motor and the lamp assembly.

21. A lamp system as defined in claim 14, wherein the lamp assembly includes slip connections for coupling the discharge lamp to a power supply.

22. A lamp system as defined in claim 14, further comprising a power supply to energize the discharge lamp and a controller to control the power supply and the rotation mechanism.
